(19) United States
(12) Patent Application Publication
(10) Pub. No.: US 2016/0053943 A1
(43) Pub. Date: Feb. 25, 2016

(54) METHOD AND FACILITY FOR SUPPLYING AT LEAST ONE MACHINING STATION WITH SUBCOOLED CRYOGENIC LIQUID

(71) Applicant: L'AIR LIQUIDE, SOCIETE ANONYME POUR L'ETUDE ET L'EXPLOITATION DES PROCEDES GEORGES CLAUDE, Paris (FR)

(72) Inventor: Pierre KOWALEWSKI, Paris (FR)

(21) Appl. No.: 14/784,820

(22) PCT Filed: Apr. 10, 2014
(86) PCT No.: PCT/FR2014/050862

§ 371 Date: Oct. 15, 2015

(30) Foreign Application Priority Data
Apr. 18, 2013 (FR) 1353518

(51) Int. Cl. F17C 7/02; B26D 7/08; B23Q 11/12; F17C 13/04

(52) U.S. Cl. CPC F17C 7/02; F17C 13/04; B26D 7/08; B23Q 11/126

(57) ABSTRACT

A method for supplying subcooled cryogenic liquid to at least one station (P, P1, P2 . . . ) carrying out machining operations, from a storage tank (10), said tank containing, under a storage pressure higher than atmospheric pressure, the cryogenic fluid in the liquid phase at the bottom of the tank and in the gaseous phase at the top of the tank, said tank being suitable for supplying said station (P) with liquid drawn from the bottom of the tank (10), and for being provided with fluid from the outside, characterised in that it involves: providing at least one heat exchanger, submerged in at least one bath of said cryogenic liquid (20), controlling (3, 4) the level of the or each bath at a predefined level; passing the cryogenic liquid coming from the storage tank (10) through the or each heat exchanger before said liquid arrives at said machining station(s); regulating (1, 6, 1₂,13, 61, 62 . . . ) the pressure of the cryogenic liquid from the or each submerged exchanger before said liquid arrives at said corresponding machining station.

### CROSS REFERENCE TO RELATED APPLICATIONS

This application is a 371 of International PCT Application PCT/FR2014/050862 filed Apr. 10, 2014 which claims priority to French Patent Application No. FR 1353518 filed Apr. 18, 2013, the entire contents of which are incorporated herein by reference.

### BACKGROUND

The present invention relates to methods for supplying a user station with cryogenic liquid, in particular with subcooled cryogenic liquid; it relates very particularly to supplying stations that carry out machining (machining, cutting, etc.) operations.

There is a very extensive prior art regarding supplying such machining tools with the aid of a cooling fluid (for cooling the cutting tool, the cutting zone, etc.) and in particular with the aid of a liquid cryogen such as liquid nitrogen. The cryogen in such cases is used not only for cooling the zone but also for a cutting tool “lubricating” effect.

A cryogenic fluid is commonly understood to be a fluid which, at atmospheric pressure, is liquid at a temperature far below 0° C.

Such a cryogenic liquid (for example liquid nitrogen) is conventionally supplied to consuming equipment, irrespective of its type, from a cryogenic fluid tank connected to the equipment that consumes this fluid, said tank contains, under a storage pressure greater than atmospheric pressure, a cryogenic fluid in the liquid phase at the bottom of the tank and in the gas phase at the top of the tank, this tank being suitable for, on the one hand, supplying the consuming equipment with liquid which is withdrawn from the bottom of the tank and, on the other hand, for being provided from the outside with fluid.

Use is most commonly made in the industry of tanks referred to as “low-pressure storage tanks”, that is to say the maximum pressure of which achieved at the top of the tank is in general less than around 4 bar absolute, but, depending on the intended applications, storages referred to as medium pressure that go up to 15 bar, or even storages referred to as high pressure that go up to 30 bar, are also found.

Since the storage pressure of the tank is greater than atmospheric pressure, the opening of a valve placed on the duct for connecting the tank to the consuming equipment (for example a machining tool) causes the displacement of the liquid from its drawing point to its usage point, without forced entrainment means and despite the pressure drops over the line (valves, bent portions, etc.).

In order to ensure that the entrainment of the cryogenic liquid is always effective irrespective of the level of liquid in the tank, the pressure of the gas at the top of the tank is conventionally regulated so that this pressure remains substantially equal to a fixed predetermined value, for example of the order of 2 to 4 bar.

However, the pressure of the liquid in the bottom of the tank varies as a function of the height of the liquid inside the tank, so that, as the level of liquid drops, the pressure of the liquid withdrawn drops and tends to approach the pressure of the gas at the top. For example, in the case of nitrogen, a liquid height of approximately 10 meters involves a pressure differential of the order of 0.6 bar between the gas pressure at the top of the tank and the liquid pressure at the bottom of the tank, level with the drawing point.

This pressure variation of the liquid at the drawing point inevitably results in a variation of the flow of liquid withdrawn, leading to operating disturbances for the consuming equipment located downstream. A similar effect occurs when resupplying the tank with fluid.

For well-known reasons of better “cryogenic quality” in terms of available frigories, the literature and these industries that use cryogens are interested in means of supplying these user stations with pure or substantially pure liquid, or with subcooled liquid, that is to say with liquid at reduced pressure, and at lower temperature than when it was at higher pressure.

Indeed, considering the example of machining, the higher the spraying pressure in the machining zone, the better the heat exchange coefficients. However, when the cryogen, for example liquid nitrogen, is sprayed it creates gas —due to its expansion—at the outlet of the spray nozzle. The amount of gas generated is directly proportional to the temperature of the liquid nitrogen and to its pressure upstream of the nozzle. The interest in endeavoring to provide a subcooled liquid is therefore understood.

Certain studies have recommended the use of phase separation (degassing) means in the line connecting the tank to the consuming equipment; reference may be made for example to document EP-2 347 855.

Other solutions have proposed to couple two tanks and use them alternately after filling and depressurization. The drawbacks of this solution are obviously the very great handling induced and the mobilization of two tanks.

Another solution is to insert a heat exchanger (for example a plate heat exchanger) just upstream of the point of use: circulating in one of the channels of the exchanger (main circuit) is the liquid nitrogen to be subcooled (typically to begin with at 3 bar and a temperature close to −185° C.), circulating in another channel of the exchanger is a depressurized nitrogen, typically at a pressure close to 1 bar and at low temperature, close to −196° C. It is the exchange between these two channels, co-currently or countercurrently, that will make it possible to subcool the nitrogen of the main circuit. But the control of the temperature is here difficult to manage and to stabilize, in particular when the consuming equipment downstream operates discontinuously, obliging the exchanger to go through reheating and recooling phases, etc.

Document WO 2004/005791 in the name of the Applicant could also be consulted, which recommends varying the pressure of the gas at the top of the tank depending on the operating state of this tank (consuming phase of the user facility downstream, waiting phase, or phase of supplying the tank with cryogenic liquid), and which rightly recommends, according to one of its embodiments, the venting of the tank during waiting periods. In other words, when the tank is not subjected to withdrawal operations and will not be a priori for a significant duration, for example of several hours (for example overnight) a control unit controls the opening of a venting valve of the upper part of the tank. The gas pressure at the top of the tank then goes from a storage value to a value substantially equal to atmospheric pressure (residual pressure of a few hundreds of grams). Thus, by lowering the storage pressure of the nitrogen in this way, the enthalpy change of the latter tends to increase, which amounts to having a fluid of lower temperature than when it was under pressure. The fluid thus stored during these periods of non-use of the tank therefore has a temperature lower than the standard temperature, guaranteeing a better cryogenic quality in terms of available frigories. And in fact a rapid repressurization—by using for example its own atmospheric or other reheater—makes it possible to use the destabilized (subcooled) liquid.

Nevertheless, this solution is not without drawbacks, this venting inevitably leads to losses, and furthermore the paradox of this procedure lies in the need to re-pressurize in order to be able to use the nitrogen, therefore to let in heat. Experimentation of this solution has in particular demonstrated a vaporization of 4 to 9% of the stored volume. Since this vaporization is not exploited, the cost directly impacts the user site. In summary, two major drawbacks of this venting solution are deduced therefrom:

1) The use of non-exploitable nitrogen for the re-pressurization.

2) The entry of a hot gas into the storage for the depressurization and the creation of a thermal bridge.

It has also been thought of to supply the user station, for example machining station, directly from a medium or high-pressure cryogen storage, but then the creation is observed, at the outlet of the spray nozzle, of a large amount of gas, which gas reduces the heat exchanges.

It may finally be thought of to supply the machine from a low-pressure storage and through a pump, but the difficulties linked to handling such pumps are known, added to which is the impossibility of supplying several machining stations of a same site at different pressures and at low flow rate.

The studies completed successfully by the Applicant have demonstrated that, for such machining applications, these prior solutions, which may for example be satisfactory in other industries such as the food industry, are not completely satisfactory here, and in particular do not make it possible to supply several machining stations with a subcooled liquid, at different pressures, from a medium or high-pressure storage (for example of between 15 bar and 30 bar), for example to supply several machining stations with subcooled liquid nitrogen, at different pressures at −196° C., from an upstream storage at 15 bar.

### SUMMARY

Within this context, one of the objectives of the present invention is to propose a novel method for supplying a machining-type user site with pure or subcooled cryogenic liquid, avoiding the drawbacks of the prior art and making it possible in particular to control the pressure for supplying several machining stations simultaneously.

For this, the invention then relates to a method for supplying at least one station (P, P1, P2 . . . ) carrying out machining operations with subcooled cryogenic liquid, from a storage tank, which tank contains, under a storage pressure greater than atmospheric pressure, the cryogenic fluid in the liquid phase at the bottom of the tank and in the gas phase at the top of the tank, said tank being suitable for supplying said station(s) with liquid withdrawn from the bottom of the tank, and also for being provided from the outside with fluid, being characterized in that:

at least one heat exchanger is provided, submerged in at least one bath of said cryogenic liquid,

the level of the or each bath is controlled at a predetermined level;

the cryogenic liquid originating from the storage tank is made to pass through the or each heat exchanger before it arrives at said machining station(s);

the pressure of the cryogenic liquid coming from the or each submerged exchanger is regulated before it arrives at said machining station corresponding thereto.

The invention also relates to a facility for supplying at least one station (P, P1, P2 . . . ) carrying out machining operations with subcooled cryogenic liquid, comprising a storage tank, which tank contains, under a storage pressure greater than atmospheric pressure, the cryogenic fluid in the liquid phase at the bottom of the tank and in the gas phase at the top of the tank, said tank being suitable for supplying said station (P, P1, P2 . . . ) with liquid withdrawn from the bottom of the tank, and also for being provided from the outside with fluid, being characterized in that it comprises:

at least one heat exchanger, submerged in at least one bath of said cryogenic liquid,

means for controlling the level of the or each bath at a predetermined level;

a system of pipes suitable for making the cryogenic liquid originating from the storage tank pass through the or each heat exchanger before it arrives at said machining station(s);

means for regulating the pressure of the cryogenic liquid coming from the or each submerged exchanger before it arrives at said machining station corresponding thereto.

According to one of the embodiments of the invention, the facility comprises a valve located upstream of the inlet of liquid into each of said exchangers, each valve being in fluid communication with said tank, and said means for regulating the pressure of the cryogenic liquid coming from the or each submerged exchanger before it arrives at said machining station corresponding thereto comprise a dedicated pressure probe, positioned between the outlet of each exchanger and said machining station associated with the exchanger in question, in order to be capable of providing the information that it measures to said valve located upstream of the inlet of liquid into the exchanger in question.

According to one of the embodiments of the invention, the facility comprises one or more cooling lines, one cooling line being dedicated to each of said assemblies of the facility consisting of a bath and an exchanger, each cooling line being connected in its upstream portion to an outlet pipe from the exchanger of the bath associated with it, and in its downstream portion to a pipe for supplying the bath in question with cryogenic liquid from said tank or directly to the upper portion of a container containing the bath in question, each cooling line being provided with a temperature probe and with a valve for regulating the flow that circulates therein.

According to one advantageous embodiment of the invention, use is made of a drain, on the portion of the line between the valve for inlet of cryogen into the exchanger and the exchanger, or on all or some of the line portions between a valve for inlet of cryogen into the exchanger in question and this exchanger.

This use indeed proves to be extremely advantageous, for the following reasons, linked in particular to the fact of being able to reduce the size of the exchanger on the one hand and to the fact of optimizing the heat exchanges on the other hand:

during the expansion of the cryogenic fluid, it spontaneously creates gas, linked to its equilibrium temperature (liquid/vapor curve). By way of illustration, when pressurized liquid nitrogen is expanded, it creates a large amount of gas by volume: for example by expanding from 15 bar to 7 bar, there is 30% gas by mass but 10 times more gas by volume, i.e. 7.5 m³ of gas per 0.7 m³ of liquid. By eliminating or reducing this gaseous volume to be recondensed, the diameters of the piping and the lengths are optimized.

the advantage of reducing the two-phase content has moreover already been commented upon above in terms of thermal efficiency.

Such a drain therefore makes it possible to eliminate a gaseous volume to be recondensed.

### BRIEF DESCRIPTION OF THE DRAWINGS

It will furthermore be noted that the consumption of liquid cryogen, for example of liquid nitrogen, will be identical with or without a drain; since the bath of liquid is open to the air, the non-condensed portion is not surplus to the total consumption.

Other features and advantages will emerge from the following description, of exemplary embodiments of the invention, given in particular with reference to the appended figures:

FIG. 1 illustrates one of the embodiments of the invention supplying a single machining station;

FIG. 2 illustrates an embodiment of the invention supplying several machining stations simultaneously;

FIG. 3 illustrates an embodiment of the invention which uses a drain downstream of the regulating valve 1 (between the valve and the exchanger submerged in the bath 20).

### DESCRIPTION OF PREFERRED EMBODIMENTS

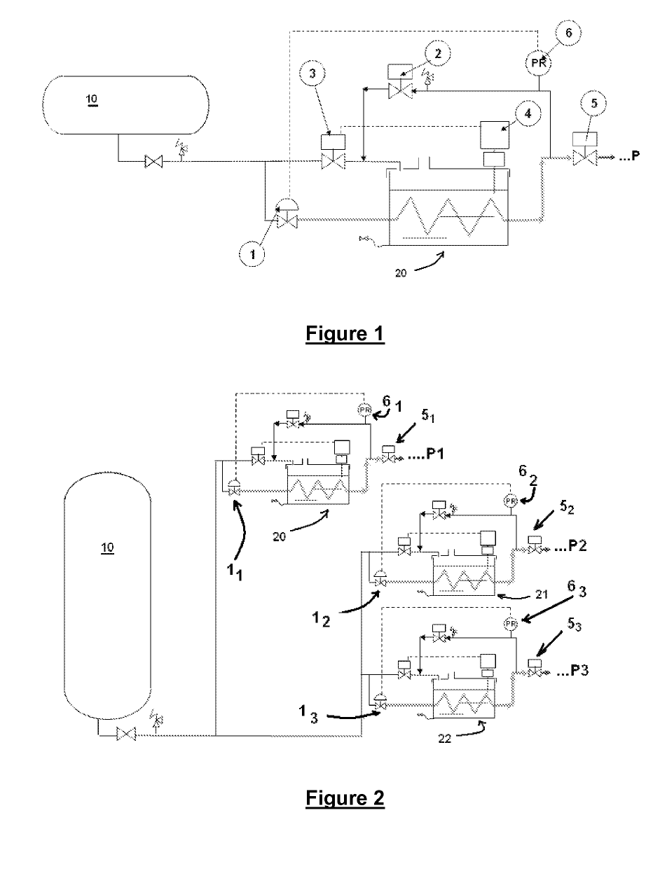

The following elements are then recognized in FIG. 1:

the embodiment represented here is used to supply a single machining station P with liquid nitrogen, from a liquid nitrogen storage tank 10;

the tank 10 contains, under a storage pressure of 15 bar, the cryogenic fluid in the liquid phase at the bottom of the tank and in the gas phase at the top of the tank, the tank is fitted and equipped with pipes necessary and well known to person skilled in the art suitable for supplying said station (P) with liquid withdrawn from the bottom of the tank 10, and also for being provided from the outside with fluid;

a bath 20 of said cryogenic liquid (here liquid nitrogen) in which a heat exchanger is submerged;

means for controlling the level of the bath at a predetermined level, here consisting of a valve 3 and a level detector 4. It is understood on studying the figure that the measurement of the level via the detector 4 makes it possible to relate back to the valve 3 for inlet of cryogen into the bath in order, depending on the case, to stop this provision or to continue it or else to start it, this aspect will not therefore be dwelt on more;

the presence of means for regulating the pressure of the cryogenic liquid coming from the submerged exchanger before its arrival at said machining station P, in the particular case here a pressure probe 6 capable of providing the information that it measures to a valve 1 located upstream of the inlet of liquid into the submerged exchanger, makes it possible to regulate the pressure arriving at the station P downstream at a desired pressure, this pressure is hence known, stable, with no need to use other means, and in particular with no need for a pump;

the presence is also noted in this FIG. 1 of a line for cooling or normal operation of the facility: the valve 5 being closed, once the bath 20 is brought to the required liquid level (valve 3, probe 4), liquid is let into the exchanger via the valve 1, then return to the line 6/2, and after to the subcooler tank.

Advantageously, the opening of the valve 2 may be time delayed, and associated with a temperature reading between the outlet of the exchanger and the valve 5, supplying the cooling and the keeping cold of the portion of pipe comprising the exchanger up to the valve 5 and an almost instantaneous availability of the cryogen at the user station.

The composition of the facility from FIG. 2 is hence clearly understood, which figure illustrates an embodiment of the invention supplying several machining stations P1, P2, P3 . . . simultaneously if necessary, each station having to be supplied with a different pressure. Recognized in FIG. 2 is the fact that three assemblies of the type of that from FIG. 1 are supplied from the storage 10 owing to three parallel lines, supplying three baths (20/21/22) in which a heat exchanger is submerged, by passing through a supply valve 1₁, 1₂, 1₃, each bath is equipped with its system for controlling the level of the bath, each assembly is equipped with its system for regulating the pressure arriving at the valve 5₁, 5₂, 5₃, and with its line for rapid cooling of the submerged portion up to the valve 5₁, 5₂, 5₃.

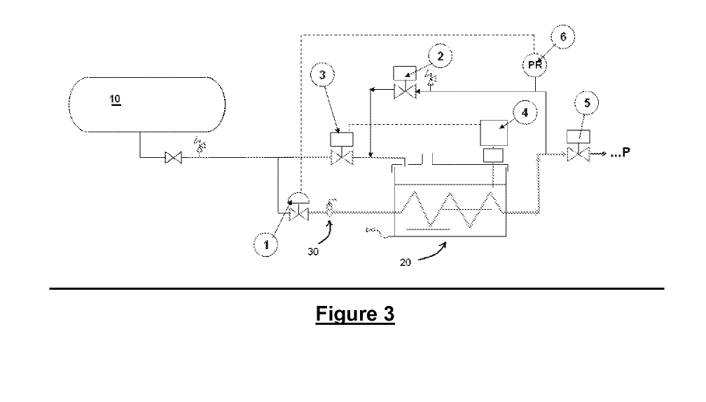

FIG. 3 therefore illustrates an embodiment of the invention which uses a drain downstream of the regulating valve 1 (between the valve and the bath 20). FIG. 3 repeats FIG. 1, a drain 30 having been positioned between the valve 1 and the bath 20.

Of course, such a drain may be present in all or some of the lines of a multi-line facility such as that from FIG. 2, therefore in all or some of the line portions 1₁-20, 1₂-21, 1₃-22, etc. i.e the line portions between the valve for inlet of cryogen into the exchanger in question of the line in question and this exchanger.

1-5. (canceled)

6. A method for supplying at least one station carrying out machining operations with subcooled cryogenic liquid, from a storage tank, the tank containing, under a storage pressure greater than atmospheric pressure, the cryogenic fluid in the liquid phase at the bottom of the tank and in the gas phase at the top of the tank, the tank being suitable for supplying said station with liquid withdrawn from the bottom of the tank, and also for being provided from the outside with fluid, wherein:
at least one heat exchanger is provided, submerged in at least one bath of said cryogenic liquid,
the level of the or each bath is controlled at a predetermined level;
the cryogenic liquid originating from the storage tank passes through the at least heat exchanger before it arrives at said at least one station;
the pressure of the cryogenic liquid coming from the at least one submerged exchanger is regulated before it arrives at said at least one station corresponding thereto.

7. A facility for supplying at least one station carrying out machining operations with subcooled cryogenic liquid, comprising a storage tank, the tank containing, under a storage pressure greater than atmospheric pressure, the cryogenic fluid in the liquid phase at the bottom of the tank and in the gas phase at the top of the tank, said tank being suitable for supplying the at least one station with liquid withdrawn from the bottom of the tank, and also for being provided from the outside with fluid, comprising:
at least one heat exchanger, submerged in at least one bath of said cryogenic liquid),
a means for controlling the level of the or each bath at a predetermined level;
a system of pipes suitable for making the cryogenic liquid originating from the storage tank pass through the at least one heat exchanger before it arrives at the at least one machining station;
a means for regulating the pressure of the cryogenic liquid coming from the at least one submerged exchanger before it arrives at the at least one station corresponding thereto.

8. The facility as claimed in claim 7, further comprising a valve located upstream of the inlet of liquid into each of the one or more exchangers, each valve being in fluid communication with the tank, and in that the means for regulating the pressure of the cryogenic liquid coming from the at least one submerged exchanger before it arrives at the one or more station corresponding thereto comprise a dedicated pressure probe, positioned between the outlet of each exchanger and said machining station associated with the exchanger in question, in order to be capable of providing the information that it measures to said valve located upstream of the inlet of liquid into the exchanger in question.

9. The facility as claimed in claim 7, further comprising one or more cooling lines, one cooling line being dedicated to each of said assemblies of the facility consisting of a bath and an exchanger, each cooling line being connected in its upstream portion to an outlet pipe from the exchanger of the bath associated with it, and in its downstream portion to a pipe for supplying the bath in question with cryogenic liquid from said tank or directly to the upper portion of a container containing the bath in question, each cooling line being provided with a temperature probe and with a valve for regulating the flow that circulates therein.

10. The facility as claimed in claim 8, further comprising a drain on one or on all or some of the line portions between a valve and the inlet of liquid into the exchanger associated with the valve in question.
